(19) United States
(12) Patent Application Publication
(10) Pub. No.: US 2013/0149021 A1
(43) Pub. Date: Jun. 13, 2013

(54) APPLICATOR DEVICE

(71) Applicant: George Kast, Wongawallan (AU)

(72) Inventor: George Kast, Wongawallan (AU)

(21) Appl. No.: 13/809,363

(22) PCT Filed: Jul. 8, 2011
(86) PCT No.: PCT/AU2011/000871

§ 371 Date: Jan. 25, 2013

(30) Foreign Application Priority Data
Jul. 9, 2010 (AU) 2010903049

(51) Int. Cl. B05C 1/00

(52) U.S. Cl. CPC B05C 1/00
USPC 401/146; 222/282; 222/209; 137/798

(57) ABSTRACT

A liquid applicator (10, 10A, 10B, 10C, 10D) having (i) a container (ii) for containing a supply of liquid in use; a positive displacement pump (12) in fluid communication with the container (ii) which has a variable capacity chamber for delivering a metered or measured dosage of liquid; (iii) a support housing or tube (19) which Is in flow communication with the positive displacement pump (12) and a contact device (20, 46A, 60) located adjacent to the support housing or tube (19) which is in flow communication therewith wherein metered amount(s) of liquid are delivered to a plant or other substrate. In another variation the positive displacement pump (12) Is replaced by a pump such as a bellows type pump (68) which also functions as a container for the fluid.

### FIELD OF THE INVENTION

This invention relates to an applicator device which may be utilised for selective delivery of fluids inclusive of liquids and gels to a desired substrate such as plants and other forms of vegetation and other substrates.

### BACKGROUND TO THE INVENTION

Applicator devices are well known and reference may be made for example to U.S. Pat. No. 4,072,128 which comprises a body member of a liquid reservoir therein, a manually operable pump in communication with the reservoir and an applicator post mounted on the pump which may be connected to a hose. A metered amount of liquid is supplied to an inner surface of a portion of a tubular member by manually placing the tubular member portion over the applicator post and then pressing inwardly over the device.

Reference also may be made to U.S. Pat. No. 5,690,738 which described a liquid dispenser and contact applicator having at least one roller for contacting advancing work pieces and applying liquid to surfaces thereof as they pass. Use is made of a cyclically repeatable volumetric displacement pump which meters predetermined quantities of the liquid from a source to a dispensing tube extending axially along the applicator member

However it will be appreciated in regard to both U.S. Pat. Nos. 4,072,128 and 5,690,738 that these applicator devices would not be suitable for applying herbicides to plants as the substrate which is to be contacted by these applicator devices includes work pieces in the case of U.S. Pat. No. 5,690,738 and an internal surface of a tube in the case of U.S. Pat. No. 4,072,128. It will also be appreciated that the structure of these applicator devices are relatively complicated.

Reference may also be made to U.S. Pat. No. 6,092,952 which describes an applicator bottle having a hand grip neck, a trigger mounted for index finger operation of a pump whereby the pump delivers liquid by the bottle. An important feature of this invention however is the provision of an upwardly canted backing plate having a sponge wherein the angle of canting is about 20 to 30 degrees. Again the structure of this applicator is unnecessarily complicated having regard to the use of a upwardly canted backing plate.

Reference also may be made to U.S. Pat. No. 6,145,703 which is a multi-dose spray applicator for dispensing a pharmaceutical liquid from a sealed container wherein use is made of a manually operable metering pump for delivery the pharmaceutical as a nasal spray. Reference is also made to a hollow needle associated with the pump for penetrating a membrane sealing the container and dispensing the pharmaceutical liquid through the pump. Again this applicator would not be suitable for application to plants and is unnecessarily complicated having regard to the feature of the hollow needle.

Finally reference may be made to AU Patent 673075 which describes a liquid applicator head which can be fastened to a bottle, tube or other reservoir. The liquid applicator head has a body, a brush extending from the body and a valve assembly within the body to enable supply of liquid. The brush is associated with the valve assembly so that movement of the brush causes actuation of the valve assembly and consequent supply of liquid. The brush can be a bristle brush or an open cell foam brush. The applicator head can be used for applying herbicides or other liquids to plants. Again it is considered that the structure of this applicator head is unnecessarily complicated in that it requires a valve assembly which is dependant upon movement of the brush and consequent supply of liquid to the plants.

### OBJECT OF THE INVENTION

It is therefore an object of the invention to provide an applicator device which is simple in structure and which may alleviate disadvantages of the prior art described above. The applicator device of the invention is also particularly suited for application to substrates inclusive of plants.

This invention in a first aspect provides a liquid applicator which has:
(i) a container for containing a supply of liquid in use;
(ii) a positive displacement pump in flow communication with the container which has a variable capacity chamber for delivering a metered or measured dosage of liquid;
(iii) a support housing or tube having which is in flow communication with the positive displacement pump; and
(iv) a contact device located adjacent to the support housing or tube which is in flow communication therewith wherein metered amount(s) of fluid are delivered to a plant or other substrate.

Preferably there is provided an internal compartment located adjacent to the contact device and in flow communication with the support tube which has a volumetric capacity greater than the metered dose of liquid whereby said metered dose is delivered to said internal compartment and retained therein prior to being delivered to the contact device.

In this first aspect of the invention the container for containing the supply of liquid may be a bottle carried in a knapsack or a belt worn by the user or a knapsack tank or cylinder carried on the back of the user or operator. In each of these arrangements the container may have an outlet connected to a feed hose or conduit which may be in the form of a flexible hose or rigid conduit as the case may be which connects the container and the positive displacement pump.

The positive displacement pump used in the invention may be of any suitable type and thus may comprise a reciprocating pump such as direct action piston or diaphragm which can be used to deliver a controlled or metered amount of fluid. A peristaltic pump or bellows-type pump may also be used. The pump is preferably self-priming so that the liquid need not be supplied to it under pressure. The pump is most suitably a cyclically operable volumetric metering device. A particular pump that may be used in the aspect of the invention is shown in U.S. Pat. No. 7,690,738. The pump for use in the invention is suitably manually operable such as by the use of a trigger connected to the pump or by the use of a manually operable rod which may be actuated against the bias of a spring.

The support housing or tube for use in the invention may enclose the positive displacement pump in one arrangement and thus be operated by a trigger device located externally of the support housing or tube. In an alternative arrangement the positive displacement pump may be separate from the support housing or tube and thus be operated by the trigger device which is located externally of the pump. In either arrangement the trigger device may bear against or is in abutment with a reciprocating member of the pump such as a piston or diaphragm.

The metered amount of liquid may be delivered to the internal compartment preferably through a supply hose or rigid tube located within the support housing or tube.

The contact device for use in the invention may be a brush, roller, wiping sleeve or sheet and is preferably attached to an adjacent end of the support housing or tube by a holder which may be surrounded by the internal compartment. There also may be provided an internal partition between the support housing or tube and the internal compartment which may contain a flow aperture for passage of fluid travelling in the supply hose or rigid tube to the internal compartment. The holder may also be attached to the internal partition.

In another embodiment of the invention the internal compartment may be dispensed with and a contact device is located at one end of the support housing or tube which may be a pad so that metered amount(s) of fluid may be passed to the pad.

In a second aspect of the invention the invention may provide a liquid applicator device including:
(i) a container containing a supply of liquid in use;
(ii) a pump;
(iii) a support housing or tube having a contact device for contacting a plant which is in flow communication with the pump; and
(iv) an actuating cable, rod or other elongate line member which is operably connected to the contact device for causing movement of the contact device or the pump which results in delivery of said fluid to a plant or other substrate.

In this aspect of the invention in one embodiment there also may be provided a container of liquid which is in flow communication with the pump which may be manually operable by the trigger describes above. The pump may be in fluid communication with the support housing or tube so that liquid may be caused to flow to the contact device which in this embodiment may comprise a pair of opposed jaws preferably having pads attached thereto which may be moved inwardly and outwardly in a reciprocating movement by movement of the actuating cable or rod wherein the substrate which is located between the jaws may be contacted by the liquid. Alternatively and less preferably only one jaw or other contact device may be used.

In another embodiment the pump may also function as the container so that components (i) and (ii) are the same. Thus in this embodiment there may be provided an operating handle having a trigger or rod for actuation of the cable or rod. There also may be provided a bellows type pump suitably having a corrugated and flexible side wall to which the operating cable or rod is attached at one end thereto so that reciprocal action of the cable or rod causes an inward movement followed by an outward movement of the side wall of the bellows pump which causes liquid to be pumped out of the bellows pump onto a brush or pad located at an adjacent end of the support housing or tube.

The invention also includes in a preferred embodiment an improved coupling which may be utilised to interconnect the contact device and the support tube or housing and also the internal hose or rigid tube as hereinafter described. This provides the advantage that the separate components of the invention such as the contact device and associated fittings as discussed hereinafter may be carried in a belt worn by the user and maybe selectively attached to the support tube or housing as may be required having regard to the particular application desired.

More preferably the coupling includes a female coupling having a pair of inner and outer bayonet connections which engage simultaneously with corresponding bayonet connections of a male coupling. As a result of such engagement movement of a valve member will open a floor aperture for passage of fluid through the coupling.

### PREFERRED EMBODIMENT

Reference may be made to preferred embodiments applicator of the invention as shown in the attached drawings wherein:

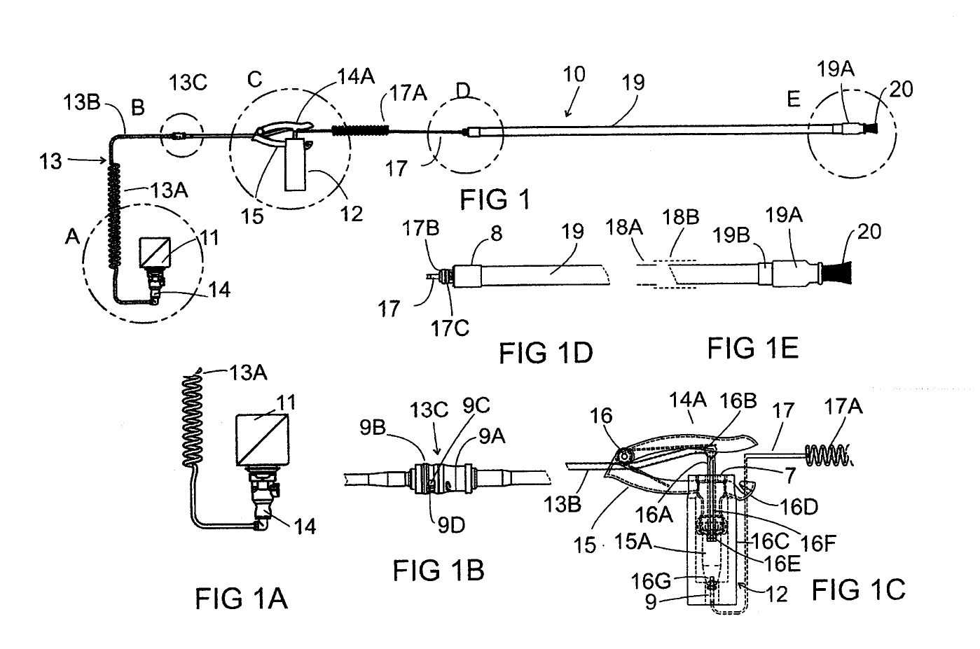

FIG. 1 is a side view of a first embodiment of the applicator;

FIG. 1A is an enlarged view of detail “A” shown in FIG. 1;

FIG. 1B is an enlarged view of detail “B” shown in FIG. 1;

FIG. 1C is an enlarged view of detail “C” shown in FIG. 1;

FIG. 1D is an enlarged view of detail “D” shown in FIG. 1;

FIG. 1E is an enlarged view of detail “E” shown in FIG. 1;

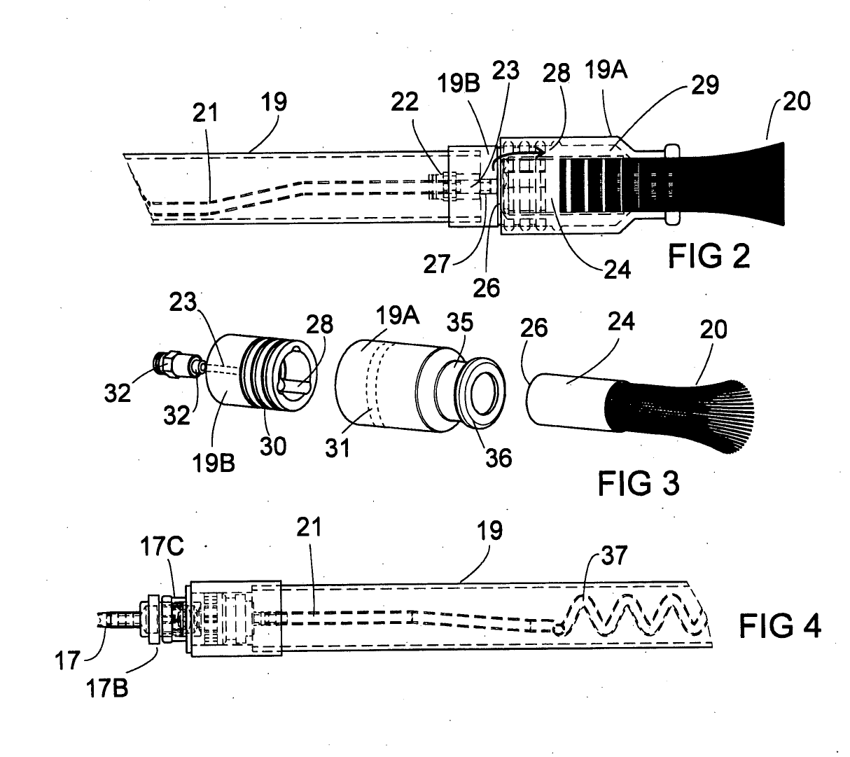

FIG. 2 is a detailed side view of detail “E” shown in FIG. 1;

FIG. 3 is an exploded perspective of the applicator of FIG. 2;

FIG. 4 is a detailed side view of detail “D” shown in FIG. 1;

FIG. 5 is a side view of a second embodiment of the applicator of the invention;

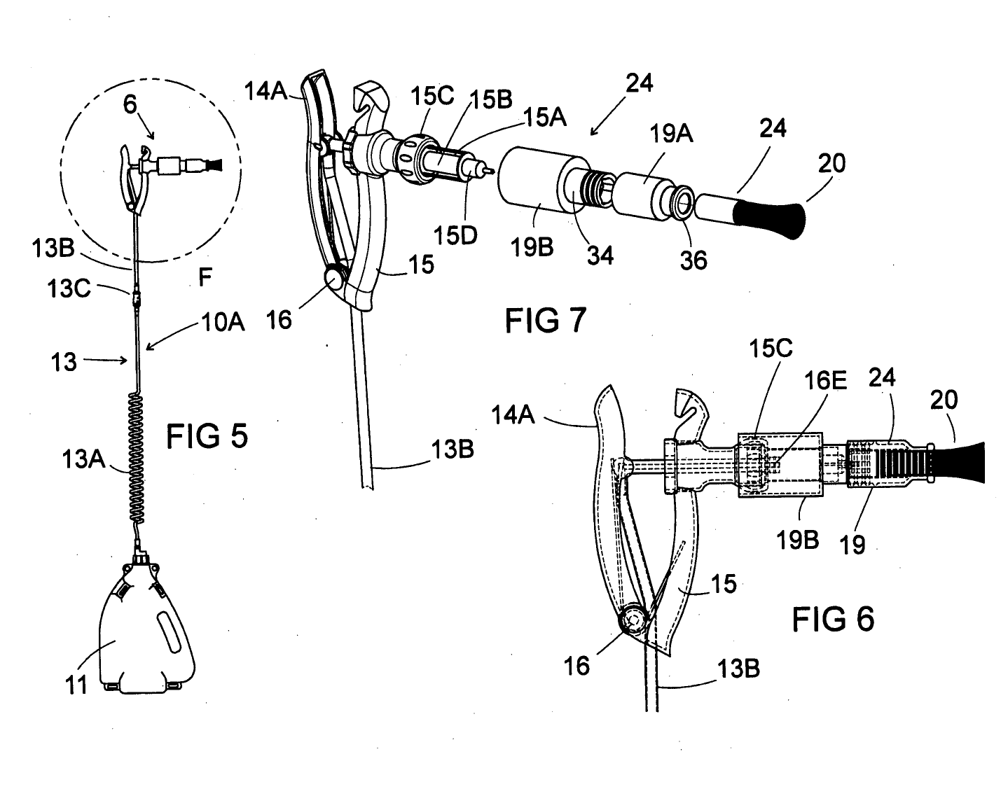

FIG. 6 is an enlarged exploded perspective view of detail “F” shown in FIG. 5;

FIG. 7 is a side view of detail “F” shown in FIG. 6;

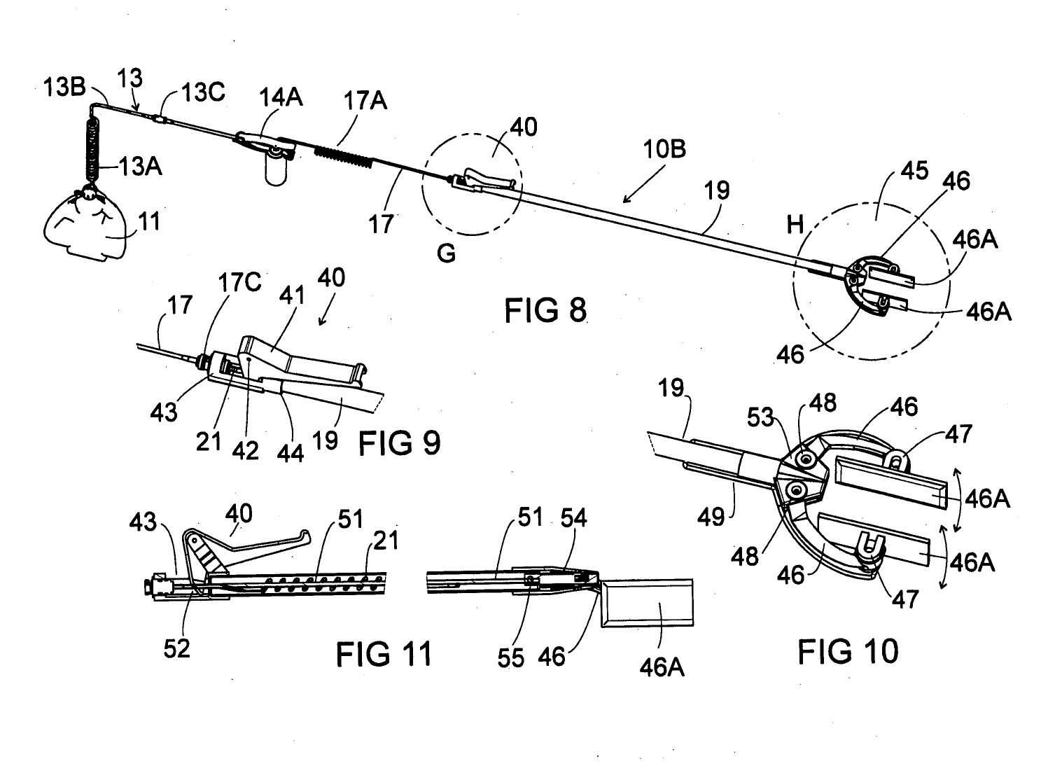

FIG. 8 is a side view of a third embodiment of the applicator of the invention;

FIG. 9 is an enlarged perspective view of detail “G” shown in FIG. 8;

FIG. 10 is an enlarged perspective view of detail “H” shown in FIG. 8;

FIG. 11 is an internal view or sectional view of the embodiment shown in FIG. 8;

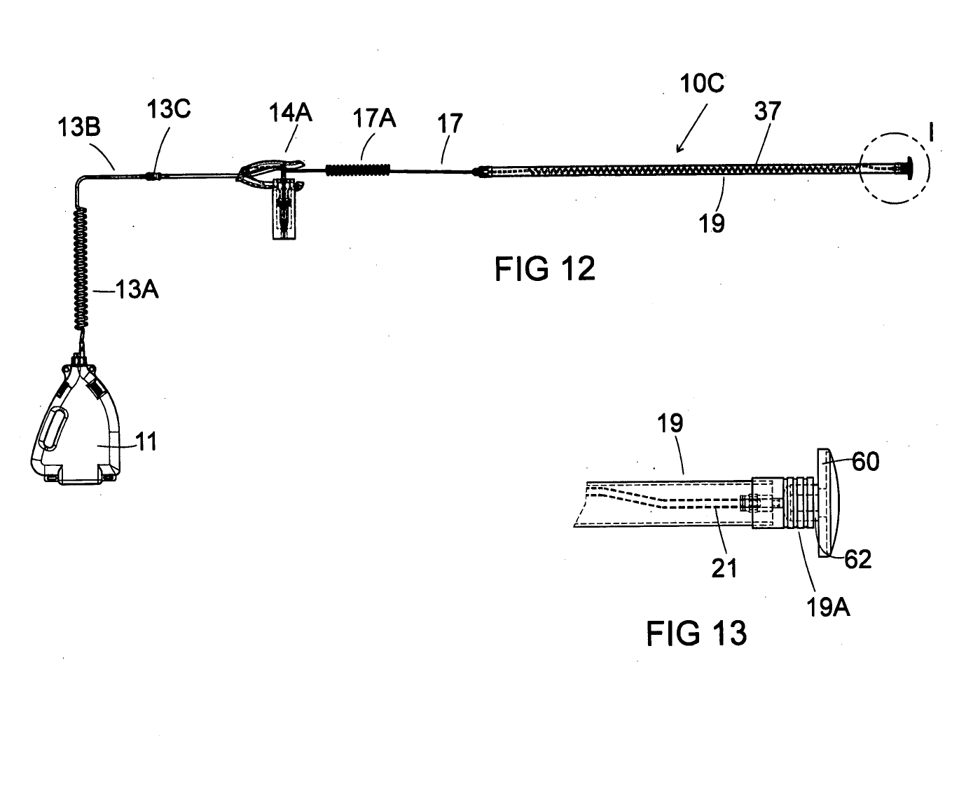

FIG. 12 is a side view of a forth embodiment of the applicator of the invention;

FIG. 13 is an enlarged view of detail “I” shown in FIG. 12;

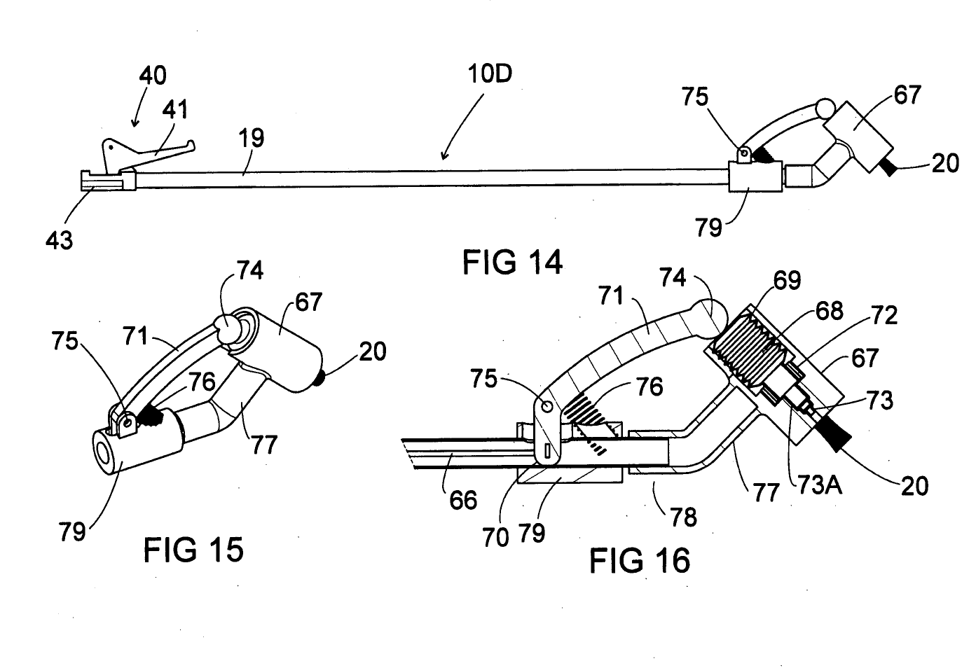

FIG. 14 is a side view of a fifth embodiment of the applicator of the invention;

FIG. 15 is an enlarged perspective view of the trigger assembly shown in FIG. 8;

FIG. 16 is an enlarged side view of the bellows bottle assembly shown in FIG. 14;

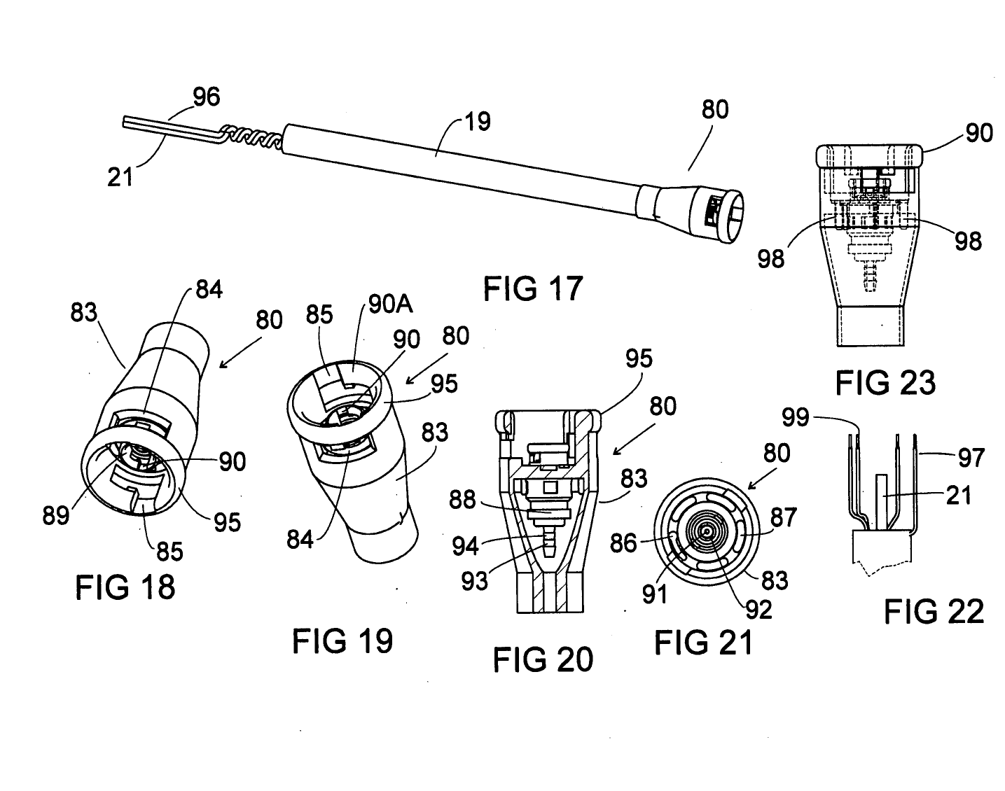

FIG. 17 is a perspective view of a tube connected to a female coupling of the invention;

FIGS. 18, 19, 20 and 21 are alternative views of the female coupling shown in FIG. 17

FIGS. 22 and 23 is an exploded perspective view of the tube and the female coupling shown in FIG. 17

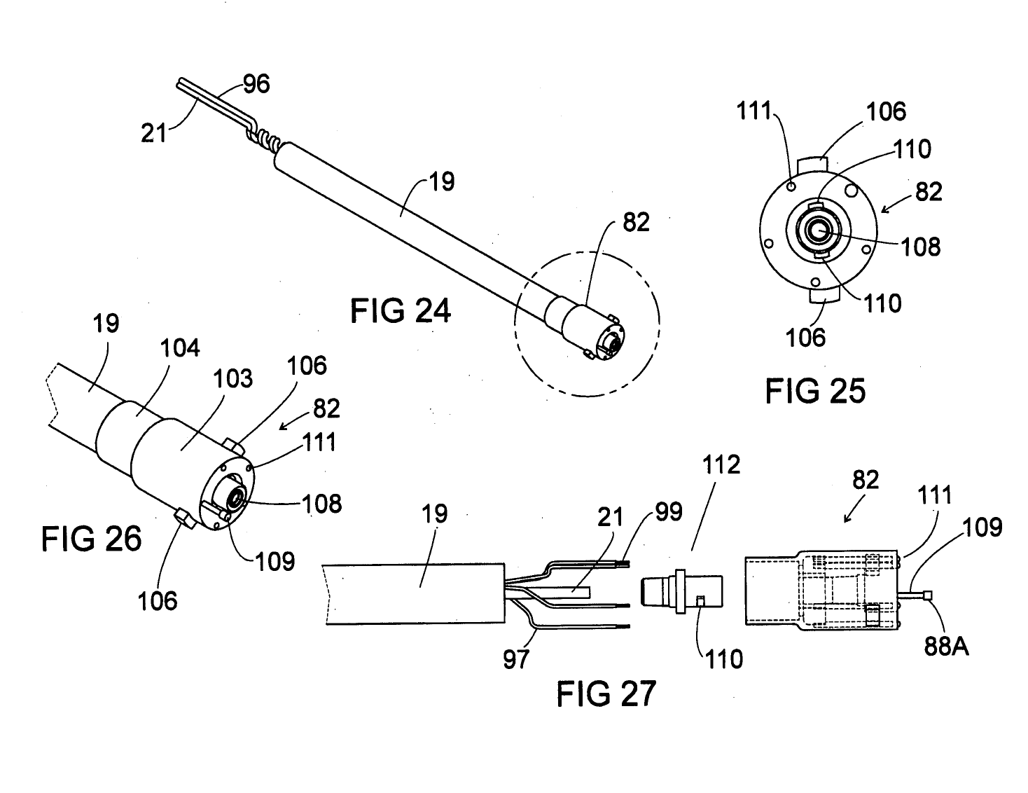

FIG. 24 is a perspective view of a tube connected to a male coupling of the invention;

FIGS. 25 and 26 show alternative views of the male coupling;

FIG. 27 is an exploded perspective view of the male coupling and an associated hydraulic coupling together with the tube shown in FIG. 24;

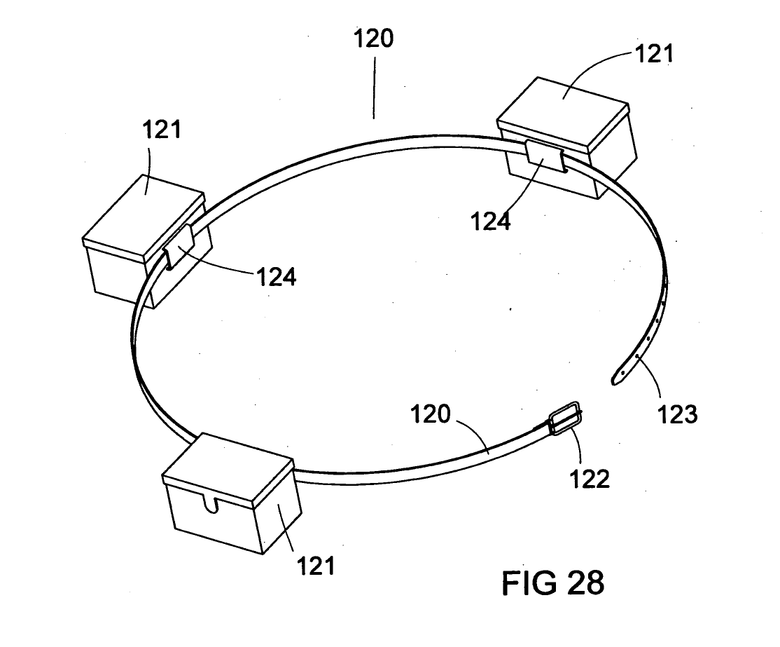

FIG. 28 is the perspective view of a belt worn by a user of the liquid applicator of the invention which may be used to carry components of the liquid applicator.

In FIG. 1 there is shown applicator 10 having a fluid reservoir tank or bottle 11 connected to a positive displacement pump 12 by means of conduit or tube 13. Conduit 13 includes flexible section 13A, pipe section 13B and releasable fitting 13C. Conduit 13 extends through inlet 14. In similar manner conduit 13 can be connected to an inlet aperture (not shown) of pump 12. Pump 12 has a trigger device 14A which is moved in a pumping action relative to a fixed handle 15.

In FIG. 1A is shown container 11 having belt apertures 11A and 11B for supporting a belt or harness (not shown) and suspension apertures 11C. There is also shown inlet 14 which has vent valve 11D and conduit section 11E which supports conduit 11F which extends to the base of container 11. In FIG. 1B there is shown releasable fitting 13C having female socket or socket 9A, male fitting 9B and a bayonet connection comprising aperture 9C and mating projection 9D.

In FIG. 1C there is shown movable trigger 14A which is pivoted to handle 15 at 16, conduit 16A attached to trigger 14A at 16B. There is also shown holster 16C for positive displacement pump 12 and suspension hook 16D. Conduit 16A is attached to a hollow piston 16E which has a one way valve and also includes check valve 16F and 16G for ensuring one way passage through conduit 16A. The lower end of pump 12 is connected to hose 17 having flexible section 17A.

FIG. 1D shows inlet 8 of rigid tube 19 connected to hose 17 wherein socket 17B engages with male part 17C. Tube 19 may be extendable having telescopic sections 18A and 18B. Tube 19 also has boot 19A which is flexible and releasably attached to holder 19B by Boot 19A also has a brush 20.

By virtue of the pumping action of trigger 14A, it will be appreciated that on each stroke of trigger device 14A, a constant or metered amount of fluid from container or bottle 11 passes through an internal conduit 16A in pump 12 and into hose 17 connecting pump 12 and elongate tube or support 19. Again hose 17 may be connected to an outlet 9 of pump 12 and an inlet 8 of tube 19 by any of the connection means referred to above.

It will be appreciated that the metered amount can be varied within pump 12 by adjustment of an adjustment screw 7 attached to the piston 16E for in pump 12.

In FIG. 1 it will be appreciated that bottle or container 11 may be worn in a knapsack or as a knapsack (not shown) on the back of a user or operator or on a belt (not shown) worn by the operator or user. Alternatively a harness or holster for container 11 may be utilised. It will also usually be worn on the belt (not shown) of a user or operator. It will also be appreciated that elongate tube 19 may be held by the hand of the user or operator in use.

In FIG. 2 there is shown an enlarged view of detail E shown in FIG. 1 which shows rigid tube 19 and brush 20. Brush 20 is supported solely by holder 19B which is releasably attached to internal conduit 21 of tube 19 at 22. Holder 19B has an internal passage 23 and brush 20 has a ferrule 24 which releasably engages with holder 19B by screw thread engagement, bayonet connection, interference fit or other plug-socket form of engagement. Ferrule 24 has a closed end 26 thus forcing liquid flow from traverse passage 27 of holder 19B as shown by the arrow to flow through outer galleries 28 of holder 19B to an internal compartment 29 which is formed between ferrule 24 and associated brush 20 and an outer housing or boot 19A formed of flexible material such as rubber or elastomeric material. Fluid in the form of a metered or calculated dose moves into compartment 29 which has a larger capacity than the metered or calculated dose so that different dosages may be utilised. The purpose of boot 19A is to form a seal for compartment 29 to prevent escape of fluid from compartment 29 and also to direct flow of fluid onto brush 20. Thus in use fluid is drained out of compartment 29 onto brush 20 which may be applied to suitable vegetation such as weeds, noxious plants and the like. The advantage of including compartment 29 is that it functions as a buffer zone between activation of trigger device 14A and the amount or quantity of fluid drained from brush 20 onto suitable plant (not shown)

In FIG. 3 there is also shown grooves 30 on holder 19B onto which the boot 19A seals. The boot 19A has internal ribs 31 that mate with grooves 30. There is also shown connector 32 used for releasable connection 22 which screw threadedly attaches to external conduit 21 at 33 and has hollow plug 34 for communicating with internal passage 23. Boot 19A also has a hollow end portion 35 for engagement with brush 20 to create internal compartment 29. Hollow end portion 35 also has end flange 36.

FIG. 4 also shows conduit shown looped or coiled part 37 of conduit 21. This is necessary to allow for tube 19 to be formed from telescopic components as described above.

In FIGS. 5-7 there is shown applicator 10A having container 11 having inlet 14 which has fluid contained therein connected by hose 13B to trigger assembly which has movable trigger 14A movable relative to handle 15 as described in FIG 1C. The pump 12 also includes barrel or cylinder 15A hollow passage 15B engagement nut 15C connecting cylinder 15A to handle 15 and outlet 15D. The piston 16E is shown in FIG. 6 there is also shown brush 20 which is connected to holder 19A in a similar manner as shown in FIG. 2. It will also be appreciated that a metered amount of fluid, upon activation of trigger 14A, moves into compartment 29 shown in FIGS. 2-3 when required in a similar manner as described for the FIG. 1 embodiment.

It will be appreciated that container 11 may be worn by the user as described above in regard to the FIG. 1 embodiment. However in the FIG. 2 embodiment the pump assembly 12 may be worn by the user in a specially designed holster (not shown) to allow use by one hand while the other hand is used for other purposes e.g. holding a cutting implement such as secateurs, tree loppers or a machete. The holster is especially designed to inhibit accidental contact of brush 20 with the operator or healthy vegetation. The holster may also have an absorbent pad (not shown) in a base part thereof to absorb any fluid that may escape from brush 20.

The applicator 10B of FIGS. 8, 9, 10 and 11 functions in the same manner as described above in the FIG. 1 embodiment in relation to container 11, hose 13 and pump 12. However pump 12 is connected to a hand piece 40 which has an operating trigger 41. Trigger 41 is pivotally mounted at 42 to support member 43 which is used for connecting to conduit 17 as well as supporting trigger 41.

Support member 43 is integrally connected to a tube 19 at 44. There is also shown at a free end 45 of tube 19, a pair of jaws or pincers 46 which are each pivotally attached to an end part 49 of tube 19 at 48.

The mechanism for movement of jaws 46 is shown in FIG. 11 wherein operating trigger 40 is operatively connected to cable 51 at 52. End part 49 also includes triangular mount 53 for jaws 46. There is also shown return spring 54 mounted on spring retainer 55.

The fluid in delivery tube 21 is delivered to pads 46A by internal tubes (not shown) which travel through pivots 48 through jaws 46 and finally through pivots 47 to pads 46A.

This embodiment is designed for the purpose to transfer fluid onto pads 46A suitably made from foam, sponge material or felt material or indeed any material that can retain fluid and transfer fluid as may be required. Suitable targets are tall plants that can be held between pads 46A by jaws 46 for application of fluid to hirsute or hairy plants for which application by a brush would be ineffective. A clump of tall grasses is another form of suitable target vegetation.

The applicator 10C shown in FIG. 12-13 functions in a similar manner as shown in FIG. 1 with the exception that the elongate tube 19 terminates in a single pad 60 of the same material as described above for pads 46A. Pad 60 has a connection tube 62 which can be connected to holder 19A by any of the releasable attachment means described above. Flexible hose 21 is in fluid communication with hose 17 as well as pad 60. The purpose of this arrangement is to provide a similar function as brush 20.

In relation to the embodiment shown in FIGS. 14, 15 and 16 there is provided an applicator 10D which has a hand piece 40 connected to tube 19 by the use of support member 43. There is also provided cable or rod 66, which is operatively connected to trigger 41. There is also provided a housing 67 which contains a removable bellows bottle 68 as shown in detail in FIG. 16. Bellows bottle 68 has a wall 69 formed from flexible or resilient plastics material which is corrugated as shown. Rod 66 abuts an inner end 70 of lever 71 so that upon reciprocation of rod 66 fluid is caused to be expelled through nozzle 73 onto brush 20 which is specifically designed for application of a herbicide in the form of a gel. This embodiment is specifically designed for application to a substrate inclusive of a cut surface of a plant or to leaves or foliage. The gel is applied as a layer to the substrate. Bottle 68 has a neck portion 72 for holding nozzle 73 and associated support 73A and housing 67 holds brush 20. It will be appreciated that upon reciprocation of rod 62 the bellows bottle 68 will be squeezed which in turn causes a metered or calibrated dose of gel to be dispensed onto the substrate. Lever 71 has a free end 74 and is pivotally mounted to conduit 19 at 75.

Reference is made in FIGS. 17-23 to a female coupling 80 which may be engaged with a male coupling 82 shown in FIGS. 24-27 wherein the engagement of coupling 80 and 82 may be used to connect the brush assembly shown in FIGS. 2-4 to tube 19. Also the assembly may be used to connect the jaw assembly shown in FIGS. 8-11 to tube 19. Again in similar manner the assembly may interconnect a fitting comprising pad 60 and connection tube 62 to elongate tube 19. Also it will be appreciated that the assembly may interconnect the fitting of housing 67, bellows bottle 68, lever 71, spring 76 and support 79 to elongate tube 19.

FIG. 17 shows tube 19 having associated electrical conductors 96 which comprise a number of electrical wires or multi-strand cables.

The female coupling 80 shown in FIGS. 17-23 includes outer housing 83 which has opposed bayonet connections which includes mating slot 84 and grove 85. The outer housing 83 also has a single keyhole slot 86 shown in FIG. 21 as well as 4 electrical contact pads 87 also shown in FIG. 21. The female coupling 80 also has inner component 88 having sleeve 89, opposed bayonet connections 90 and central nipple 91 surrounded by a resilient or valve member 92. This is commonly known as a dry break coupling. There is also provided a outwardly extending hose or tube connector 93 having hose barb 94 for attachment to a tube of hose for example. The outer tube 19 is connected to outer housing 83 also as shown in FIG. 17. The outer housing 83 also has an end extension 95.

The male coupling 82 shown in FIGS. 24-27 includes cylindrical housing 103, reduced diameter part 104, bayonet lugs 106, annular end wall 107 of housing 83, internal valve pin 108 and actuator pin 109. There is also shown a plurality of electrical contact probes 111. There is also shown inner bayonet lugs 110.

In FIG. 22-23 there is shown four conductors 97 which are assembled to form cable assemblies 96 shown in FIG. 17. There is also provided lugs 98 which are part of contact pads 97 which engage with adjacent ends 99 of conductors 97.

In FIG. 27 there is shown exploded view of an assembly comprising tube 19 and associate conductors 97, hydraulic coupling 112 having bayonet lugs 110 and male coupling 82 which may be coupled to female coupling 80

In operation when male coupling 82 is fitted into female coupling 80, bayonet lugs 106 engage with associated bayonet connections 85 and simultaneously inner bayonet lugs 110 engage with associated bayonet connections 90 and also head 88A of actuator pin 109 locates in an associated keyhole slot 86. The male coupling 82 is then pushed into hollow interior 90A of female coupling 80 and rotated until lugs 106 engage with slots 84 to lock male coupling 82 within female coupling 80, Simultaneously lugs 110 engage with bayonet connections 90.

Also simultaneously the rotational movement of male coupling 82 facilitates head 88A to engage a socket (not shown) located within housing 83. The socket holds head 88A to facilitate the transfer of linear movement of pin 109 which is caused by actuation of trigger 40 caused by movement of rod or cable 51. Valve pin 108 presses against resilient sleeve 92 upon engagement of male coupling 82 with female coupling 80 to cause rearward movement of resilient sleeve 92 which opens a valve opening (not shown) for passage of fluid from tube 19 into fitting attached thereto as described above.

It will be appreciated that outer bayonet connections 85 and 106 provide mechanical strength and together with inner bayonet connections 110 and 90 provide axial alignment and means of opening the valve opening or flow aperture referred to above. The use of actuator pin 109 also provides for the transfer of linear motion through the assembly of coupling 80 and 82. Thus the invention also includes within its scope the female coupling per se and male coupling per se as well as the assembly per se

It will also be appreciated that the connection of the male and female couplings 80 and 82 will cause alignment and engagement of contact pads 87 and contact probes 111 thus allowing the flow of electrical currents through the coupling assembly

FIG. 28 shows a belt 120 having a plurality of pouches 121 which may contain fittings described above which in this case are separate from the remainder of the applicator 10, 10A, 10B, 10C and 10D and connected thereto by the male coupling 82 engaging with female coupling 80. It is also shown buckle 122, buckle holes 123 and belt loops 124 attaching pouches 121 to belt 120. The belt pouches 121 may also be used for carrying bellows bottle 68 and brushes 20.

In a variation of the above, vented container 11 may be replaced by a non vented collapsible container (not shown) which may also be carried in pouches 121.

1/ A liquid applicator having:
(i) a container for containing a supply of liquid in use;
(ii) a positive displacement pump in flow communication with the tank which has a variable capacity chamber for delivering a metered or measured dosage of liquid;
(iii) a support housing or tube having which is in flow communication with the positive displacement pump; and
(iv) a contact device located adjacent to the support housing or tube which is in flow communication therewith wherein metered amount(s) of fluid are delivered to a plant or other substrate.

2/ A liquid applicator as claimed in claim 1 having an internal compartment located adjacent to the contact device and in flow communication with the support tube which has a volumetric capacity greater than the metered dose of liquid whereby said metered dose is delivered to said internal compartment and retained therein prior to being delivered to the contact device.

3/ A liquid applicator as claimed in claim 1 or 2 wherein the container for containing the supply of liquid is a bottle carried in a knapsack or a belt worn by the user or is carried on the back of the user.

4/ A liquid applicator as claimed in claim 3 wherein the container has an outlet connected to a feed hose or conduit which interconnects the container and the positive displacement pump.

5/ A liquid applicator as claimed in any one of claims 1-4 wherein the support housing or tube encloses the positive displacement pump and is operated by a trigger device located externally of the support housing or tube.

6/ A liquid applicator as claimed in any one of claims 1-4 wherein the positive displacement pump is separate from the support housing or tube and is operated by a trigger device which is located externally of the pump.

7/ A liquid applicator as claimed in claim 2 wherein the metered amount of fluid is delivered to the internal compartment through a supply hose or rigid tube located within the support housing or tube.

8/ A liquid applicator as claimed in any one of claims 1-8 wherein the contact device is a brush, roller, wiping sleeve or sheet and is attached to an adjacent end of the support housing or tube by a holder which is surrounded by the internal compartment.

9/ A liquid applicator as claimed in claim 1 wherein the contact device is located at one end of the support housing or tube which is a pad so that metered amount(s) of fluid may be passed to the pad

10/ A liquid applicator having
(i) a container containing a supply of liquid in use;
(ii) a pump
iii) a support housing or tube having a contact device for contacting a plant which is in flow communication with the pump; and
(iv) an actuating cable, rod or other elongate line member which is operably connected to the contact device for causing movement of the contact device or the pump which results in delivery of said fluid to a plant or other substrate.

11/ A liquid applicator as claimed in claim 10 wherein the pump is manually operable by a trigger device.

12/ A liquid applicator as claimed in claim 10-11 wherein the contact device comprise a pair of opposed jaws which are moveable in an inwardly and outwardly reciprocating movement by movement of the actuating cable or rod wherein the plant or other substrate is located between the jaws is contacted by the liquid.

13/ A liquid applicator as claimed in claim 10, 11 or 12 wherein the pump also functions as the container.

14/ A liquid applicator as claimed in claim 13 wherein there is provided a trigger for actuation of cable or rod.

15/ A liquid applicator as claimed in claim 14 wherein there is provided a bellows type pump having a corrugated and flexible side wall to which the operating cable or rod is attached at one end thereto so that reciprocal action of the cable or rod causes an inward movement followed by an outward movement of the side wall of the bellows pump which causes liquid to be pumped out of the bellows pump onto a brush or pad located at an adjacent end of the support housing or tube.

16/ A coupling assembly for connecting adjacent fluid conduits which includes
(i) a female coupling having a pair of inner and outer bayonet connections and
(ii) a male coupling having corresponding inner and outer bayonet connections which simultaneously engage with the pair of inner and outer bayonet connections of the female coupling
whereby upon said simultaneous engagement occurring movement of a valve member will occur for passage of fluid through the coupling assembly.
